(19) United States
(12) Patent Application Publication
(10) Pub. No.: US 2016/0278894 A1
(43) Pub. Date: Sep. 29, 2016

(54) MULTI-FUNCTION FLOSSER

(71) Applicant: Meng Xu, Richmond (CA)

(72) Inventor: Meng Xu, Richmond (CA)

(21) Appl. No.: 14/671,149

(22) Filed: Mar. 27, 2015

(51) Int. Cl. A61C 15/04; A61C 15/02

(52) U.S. Cl. CPC A61C 15/046; A61C 15/02

(57) ABSTRACT

A multi-function dental flosser is disclosed. The dental flosser comprises a “U”-shaped or “V”-shaped floss holder portion which comprises a pair of spaced apart arms holding a length of dental floss, and a handle portion extending from the floss holder portion. The handle portion comprises a tail portion at a distal end of the handle portion opposite from the floss holder portion. The tail portion functions as a toothpick, a gum stimulator, an interdental brush, or a combination thereof. The tail portion is made of a first plastic material. The floss holder portion is made of a second plastic material. Methods for manufacturing and using the dental flosser are also disclosed.

### TECHNICAL FIELD

The present invention relates in general to dental and oral cleaning devices and in particular to multi-function flossers, and to methods for making and using the multi-function flossers.

### BACKGROUND

The spaces between teeth and the surfaces of teeth in general can be cleaned by a variety of methods including brushing, machine-driven jets of water, toothpicks and the like, and by flossing with dental floss or dental tape or similar thread. Dental floss is a cord of thin filaments generally used to remove food and dental plaque from between teeth.

One of the chief causes of caries (dental cavities) and a principal cause of periodontal (gum and root) disease is bacterial plaque formation that develops on tooth surfaces. When removed, new plaque can reform in less than 24 hours. Therefore, in order to maintain optimal dental hygiene and health, flossing should be carried out at least once per day, and preferably prior to brushing to allow the fluoride from the toothpaste to reach between the teeth.

Many people do not floss their teeth on a daily basis, because the manual procedure for using conventional dental floss is difficult and tedious. The procedure generally includes winding opposite ends of a strand of floss around one finger of each hand respectively, then attempting to position the span of floss between the fingers in a desired location in the mouth, then sliding the floss between the teeth, and finally reciprocating the floss between teeth while also moving it vertically along the tooth from tip to gum. The floss is maneuvered preferably just under the edge of the gum, held firmly against the surface of the tooth and pulled over the surface of the tooth toward the chewing edge.

The use of a dental flosser (also known as a floss holder) has made flossing more convenient and less difficult. A dental flosser generally comprises two prongs extending from a thin plastic body (or handle). A floss strand runs between the two prongs.

A conventional dental flosser is made of a rigid and inflexible plastic material. Tensioning of the floss strand occurs each time the floss strand is urged to pass into the interspace between two closely or tightly adjacent teeth. If the dental flosser which holds the floss strand is not rigid enough, the tensioning of the floss strand could cause the dental flosser to deform, and the floss strand could takes a generally V-shaped configuration as penetration of the interspace is begun. If the dental flosser is not rigid enough and deforms easily, it would be difficult for the floss strand to pass through the interspace between two closely or tightly adjacent teeth.

Some manufacturers have produced dental flossers wherein the handle portion of the dental flosser tapers at its end in the shape of a toothpick. An example of a dental flosser wherein the handle portion tapers at its end in the shape of a toothpick is disclosed in U.S. Pat. No. 7,997,287 (entitled “dental flosser with tongue cleaner”). U.S. Pat. No. 7,997,287 teaches that the dental flosser is of one-piece molded plastic construction. If the entire dental flosser is made of a rigid and hard plastic material, the tapered end of the handle portion in the shape of a toothpick can pose safety issues, as the tapered end could potentially scratch, cut, bruise or otherwise harm the user's gums or skin.

Therefore, it is desirable to provide an improved dental flosser that is both effective and generally safe.

In addition to brushing and flossing the teeth, massaging the gums regularly can also help to keep the gums healthy and firm by stimulating the blood flow to the gums (gingival tissues). The gums need to be healthy to hold the teeth in place and keep the teeth healthy. Some people use a gum stimulator to massage their gums. For example, U.S. Design Pat. No. D161873 discloses a stand-alone gum stimulator which comprises an elongated handle and a gum-massaging head. A drawback with the stand-alone gum stimulator as disclosed in U.S. Design Pat. No. D161873 is that people tend to forget to use the gum stimulator on a regular basis. Also, the tapered end of the flosser in U.S. Pat. No. 7,997,287 is not suitable as a gum stimulator, because the tapered end (which is made of a rigid and hard plastic material) could potentially scratch, cut, bruise or otherwise harm the user's gums or skin.

Therefore, it is desirable to provide a gum stimulator product that a user can remember to use on a regular basis.

### BRIEF DESCRIPTION OF DRAWINGS

In drawings which show non-limiting embodiments of the invention:

FIG. 1 shows a side view of a dental flosser according to an example embodiment of the invention.

FIG. 1A is a three-dimensional perspective view of the dental flosser of FIG. 1.

FIG. 2 shows the floss holder portion and the sheath portion of the dental flosser of FIG. 1, separate from the insert portion and the tail portion of the dental flosser.

FIG. 3 shows the insert portion and the tail portion of the dental flosser of FIG. 1, separate from the floss holder portion and the sheath portion.

FIG. 4 schematically illustrates an example process for making a dental flosser according to an example embodiment of the invention.

FIGS. 5 to 7 schematically illustrate how a user may use a dental flosser according to an example embodiment of the invention for teeth cleaning, flossing and gum massaging.

FIG. 8 shows a side view of a dental flosser according to another example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

One aspect of the invention relates to a dental flosser. The dental flosser may be an “F”-shaped dental flosser, or a “Y”-shaped dental flosser, or a dental flosser of some other suitable shape. The dental flosser may be a multi-function dental flosser comprising not only a tool for flossing teeth, but also a tool for another function. In some embodiments, the dental flosser comprises a toothpick portion at a first end of the dental flosser and a floss holder portion (which holds a strand of floss) at a second end which is opposite from the first end. The floss holder portion and the toothpick portion may be connected by a middle portion therebetween, which serves as a grip portion to enable a user to grab or hold the dental flosser. In some embodiments, the dental flosser comprises a gum stimulator portion at a first end of the dental flosser and a floss holder portion at a second end which is opposite from the first end. In some embodiments, the dental flosser comprises a combined toothpick and gum stimulator portion at a first end of the dental flosser and a floss holder portion at a second end which is opposite from the first end, wherein the combined toothpick and gum stimulator portion functions as both a toothpick and a gum stimulator. In some embodiments, the dental flosser comprises an interdental brush portion at a first end of the dental flosser and a floss holder portion at a second end which is opposite from the first end. The interdental brush portion may comprise a plurality of protrusions extending generally radially or perpendicularly from a stem portion. The interdental brush portion may be insertable into a gap between a user's gum and two adjacent teeth (called interdental triangle). In some particular embodiments, the interdental brush portion functions not only as an interdental brush, but also as a toothpick and/or a gum stimulator.

The dental flosser is fabricated from two or more different materials having different physical and/or chemical properties. In some embodiments, the toothpick, gum stimulator and/or interdental brush portion of the dental flosser is made of a first material whereas the floss holder portion is made of a second material, and the first material is softer or more flexible than the second material.

The first material may comprise a polymer or copolymer material. The first material may comprise a thermoplastic material. The first material may comprise a composite material. In some particular embodiments, the first material may comprise ethylene-vinyl acetate (EVA) copolymer or low density polyethylene (LDPE). Ethylene-vinyl acetate (EVA) is also known as poly(ethylene-vinyl acetate) (PEVA), and is the copolymer of ethylene and vinyl acetate. EVA is a polymer that approaches elastomeric materials in softness and flexibility, yet can be processed like other thermoplastics. LDPE is a thermoplastic made from the monomer ethylene. LDPE generally has a density range of 0.910-0.940 g/cm³, and is quite flexible and tough.

The second material may comprise a polymer or copolymer material. The second material may comprise a thermoplastic material (e.g., ABS, polyethylene, polypropylene, polystyrene, or some other suitable thermoplastic material). The second material may comprise a composite material. In some particular embodiments, the second material may comprise polypropylene (PP) or polystyrene (PS) or ABS.

The hardness or softness of some thermoplastic materials may be influenced by its glass-transition temperature (Tg). A thermoplastic polymer may have a glass-transition temperature, above which the thermoplastic polymer is soft and pliable, and below which the thermoplastic polymer is hard.

In some embodiments, the first material of which the toothpick or gum stimulator is made has a first glass-transition temperature (Tg1), and the second material of which the floss holder portion is made has a second glass-transition temperature (Tg2), and Tg1 is lower than Tg2. Therefore, at the same room temperature, the toothpick or gum stimulator of the dental flosser is softer than the floss holder portion of the dental flosser.

In some embodiments, the difference between Tg1 of the first material and Tg2 of the second material may be more than 5, 10, 15, 20, 25, or 30 degrees Celsius.

It should be understood that although the first material is softer relative to the second material, the first material should still have enough rigidity or toughness to enable a user to apply force through the toothpick or gum stimulator, but without hurting the user's gums or skin.

The dental flosser may comprise a first portion made of a first material and a second portion made of the second material. The first portion may comprise the toothpick and/or gum stimulator portion, or the interdental brush portion. The second portion may comprise the floss holder portion. The dental flosser may be made in a process such that a first portion of the dental flosser made of the first material is integrally united with a second portion of the dental flosser made of the second material. For example, the dental flosser may be made in a two-step injection molding process, as is discussed further below in the present disclosure.

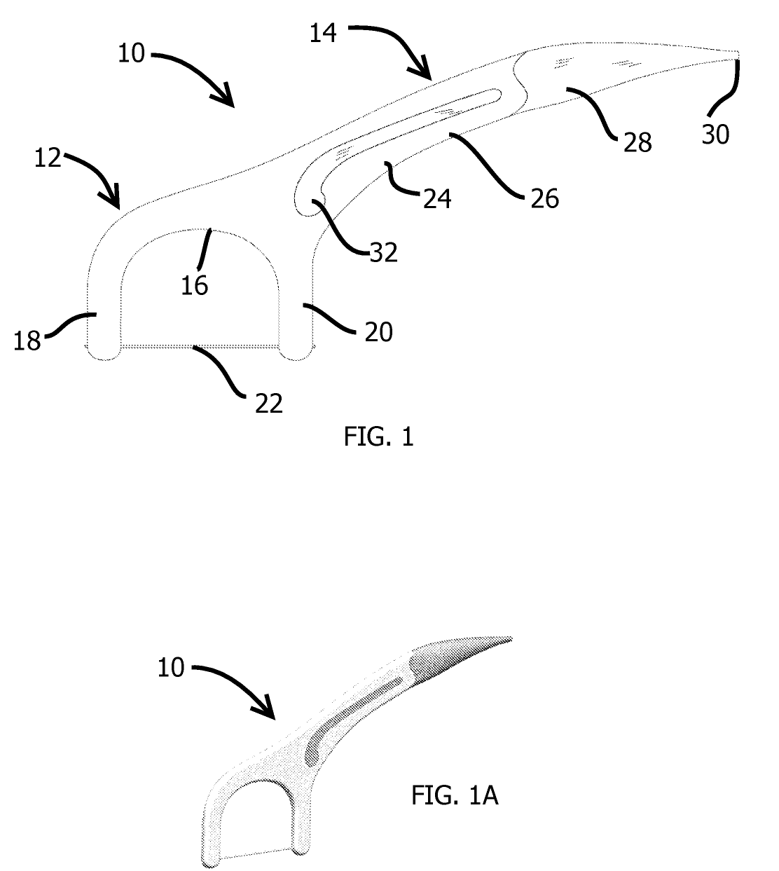

FIG. 1 shows a dental flosser 10 according to an example embodiment of the present invention. Dental flosser 10 is an example of an “F”-shaped dental flosser. Flosser 10 comprises a floss holder portion 12 and a handle portion 14. Floss holder portion 12 may be “U”-shaped or “V”-shaped. Floss holder portion 12 comprises a base 16 and a pair of spaced apart arms 18 and 20 extending from base 16. In FIG. 1, the arms 18 and 20 are shown oriented substantially parallel to one another, but it will be understood that they may be otherwise oriented so as to provide spaced apart ends for supporting a length of dental floss. A length of dental floss 22 extends between the arms 18 and 20.

Handle portion 14 comprises a sheath portion 24, an insert portion 26, and a tail portion 28. Sheath portion 24 extends from floss holder portion 12. Insert portion 26 extends from tail portion 28.

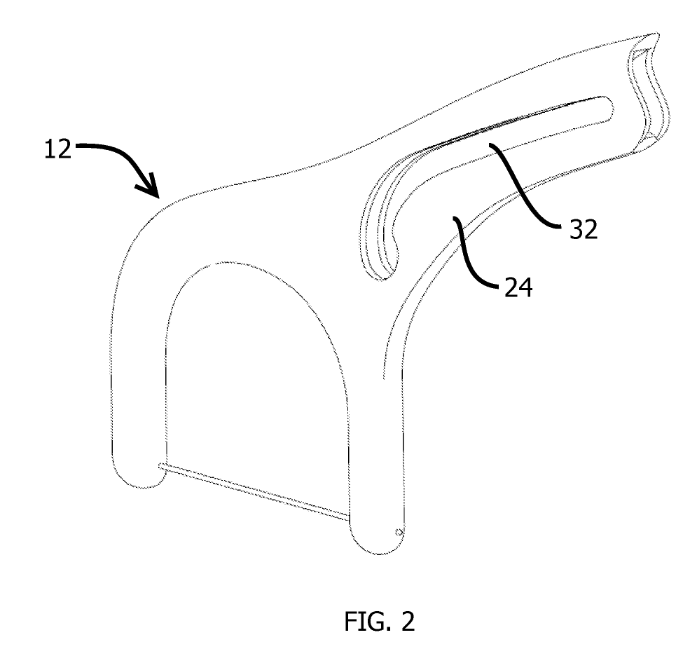

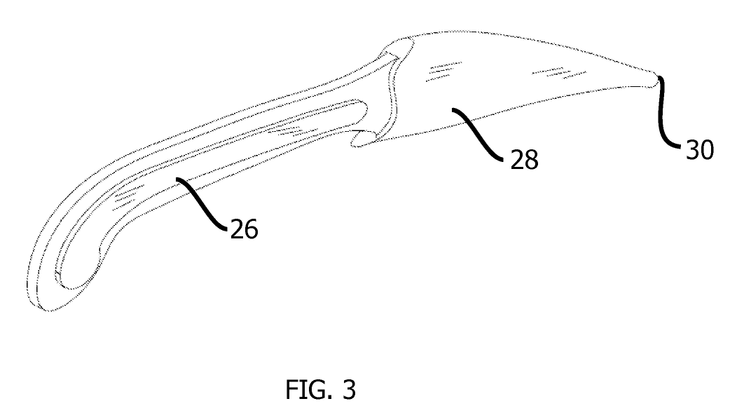

FIG. 2 shows floss holder portion 12 and sheath portion 24, apart from insert portion 26 and tail portion 28. FIG. 3 shows insert portion 26 and tail portion 28, apart from floss holder portion 12 and sheath portion 24. FIGS. 2 and 3 are included to enable a reader to better understand the spatial and structural interrelationship between the various components of flosser 10. However, in a finished product (i.e. flosser 10), floss holder portion 12 and sheath portion 24 are permanently joined to insert portion 26 and tail portion 28, and these components are not separable.

Tail portion 28 is tapered to provide a tapered end 30. Tail portion 28 with tapered end 30 may function as a toothpick or a gum stimulator or both.

Insert portion 26 and tail portion 28 are fabricated from a first material having a first hardness. The first material may be chosen from a material that is suitable for fabricating tail portion 28 such that tail portion 28 may be safely used as either a toothpick or a gum stimulator by a user without the risk of cutting or bruising the user's gums or skin. At the same time, the first material should have enough rigidity to enable the user to apply force through tail portion 28 to clean the teeth and massage the gums. In some embodiments, the first material may be a plastic material. In some embodiments, the first material may be a polymer material. In some embodiments, the first material may be a composite material. In some particular embodiments, the first material may comprise ethylene-vinyl acetate (EVA) copolymer or low density polyethylene (LDPE).

Sheath portion 24 and floss holder portion 12 are fabricated from a second material having a second hardness, which is greater than the first hardness. The second material may be chosen from a material that is suitable for fabricating floss holder portion 12 such that floss holder portion 12 can hold floss 22 in a taut and tensioned condition. In some embodiments, the second material may be a plastic material. In some embodiments, the second material may be a polymer material. In some embodiments, the second material may be a composite material. In some particular embodiments, the second material may comprise polypropylene (PP) or polystyrene (PS) or ABS.

The first and second materials may have different physical and/or chemical properties in addition to hardness. For example, the first and second materials may have different strength (e.g. shear strength, tensile strength, compressive strength, or yield strength), elasticity, plasticity, resilience, rigidity, flexibility, surface roughness, or thermal conductivity.

Dental flosser 10 is advantageous because dental flosser 10 is much safer to use. Because tail portion 28 is fabricated from a softer and more flexible material than floss holder portion 12, when a user uses tail portion 28 as either a toothpick or a gum stimulator, tapered end 30 of tail portion 28 would not scratch, cut, bruise, or otherwise harm the user's gums or skin.

Additionally, it is not necessary to make a toothpick guard or protector for the dental flosser. This streamlines the production process and reduces the amount of material used for the production of the dental flosser.

Furthermore, the dental flosser of the present disclosure has about the same total volume of materials as a dental flosser that is made using a single material. The dental flosser of the present disclosure may be a disposable dental flosser. So the first and second materials for fabricating the dental flosser may be selected from low-cost materials. In some embodiments, the first material for making the toothpick and gum stimulator portion is no more expensive than the second material for making the floss holder portion. Therefore, making the dental flosser of the present disclosure does not increase the total material cost.

As shown in FIGS. 1 and 2, sheath portion 24 encases or partially encases insert portion 26. Insert portion 26 is located inside sheath portion 24. Sheath portion 24 and inset portion 26 together form a middle portion which functions as a grip portion which enables a user to grab or hold dental flosser 10. In some embodiments, sheath portion 24 has a window 32 (e.g., an elongated window) on either side such that a part of insert portion 26 extends or is exposed through window 32. In such embodiments, sheath portion 24 and insert portion 26 may be interlocked with one another. This configuration is advantageous. As mentioned earlier, the materials for fabricating sheath portion 24 and insert portion 26 are different in their physical and/or chemical properties. For example, insert portion 26 may be softer or has a different surface texture than sheath portion 24. Because a part of insert portion 26 extends or is exposed through window 32, this could provide a better grip zone when the user is holding dental flosser 10.

Another advantage of dental flosser 10 is that dental flosser 10 comprises not only an instrument for flossing teeth, but also a toothpick and a gum stimulator, all of them on the same instrument. Therefore, when a user uses dental flosser 10 to floss his or her teeth, the user can also use the same dental flosser 10 as a toothpick or gum stimulator or both without changing tool. Also, because the gum stimulator is not a separate tool, the user will be more likely to remember to massage his or her gums using the gum stimulator portion of the dental flosser when the user is carrying out the daily task of flossing his or her teeth.

One aspect of the invention relates to methods for making a dental flosser comprising a first portion and a second portion wherein the first portion and the second portion are fabricated from two different materials. The two different materials may have different physical and/or chemical properties. For example, the two different materials may have different hardness, strength (e.g. shear strength, tensile strength, compressive strength, or yield strength), elasticity, plasticity, resilience, rigidity, flexibility, surface roughness, or thermal conductivity. The first material may be chosen from a material that is suitable for fabricating the first portion of the flosser such that the first portion may be safely used as either a toothpick or a gum stimulator by a user without the risk of cutting or bruising the user's gums or skin. The second material may be chosen from a material that is suitable for fabricating the second portion of the flosser such that the second portion can hold a length of floss in a taut and tensioned condition.

In an example method, the method comprises the followings steps: flowing a first fluid material (e.g., a first fluid plastic material) into a first mold, letting the first fluid material to harden to form the first portion of the dental flosser, transferring the first portion of the dental flosser to a second mold, flowing a second fluid material into the second mold, letting the second fluid material to harden to form a dental flosser that comprises both the first portion and the second portion. The first mold has a mold cavity that corresponds in shape to the first portion of the dental flosser. The second mold has a mold cavity that corresponds in shape to the entire dental flosser.

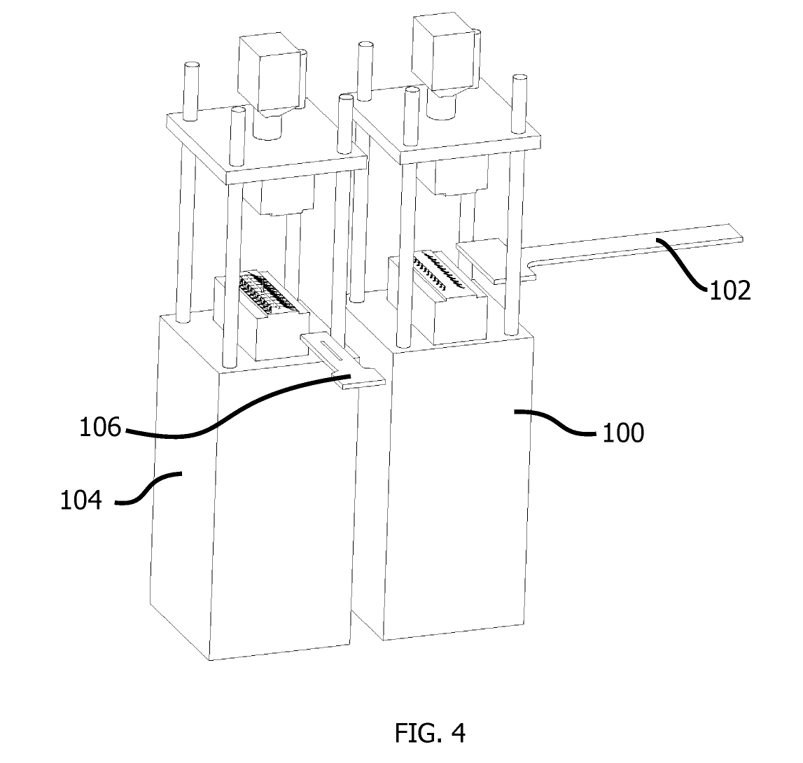

FIG. 4 shows an example process for manufacturing a dental flosser as disclosed in the present disclosure. In this process, a first fluid material (e.g., a first fluid plastic material suitable for fabricating the toothpick or gum stimulator portion of the dental flosser) is flowed into a first mold in a first injection molding machine 100. After the first fluid material hardens to form the first portion of the dental flosser, the first mold is opened, and a first robotic arm 102 picks up the first portion of the dental flosser and transfers the first portion of the dental flosser to a second mold in a second injection molding machine 104. A second fluid material (e.g., a second fluid plastic material suitable for fabricating the floss holder portion of the dental flosser) is flowed into the second mold. A length of dental floss is also placed in the second mold so that when the second fluid material hardens, the dental floss is embedded in the hardened material. After the second fluid material hardens to form a dental flosser that comprises both the first portion and the second portion, the second mold is opened, and a second robotic arm 106 picks up the dental flosser from the second mold. The dental flosser made in this two-step injection molding process comprises the first portion and the second portion integral with one another, and the two constituent portions are not separable. In some embodiments, there is no adhesion bonding or cross-linking (e.g., chemical cross-linking) between the first portion and the second portion. In some other embodiments, there may be adhesion bonding or cross-linking between the first portion and the second portion.

The first and second injection molding machines 100, 104 are configured to make a plurality of the dental flossers at the same time. For example, the first mold of the first injection molding machine 100 has a plurality of cavities, each corresponding in shape to the first portion of the dental flosser, and the second mold of the second injection molding machine 104 has a plurality of cavities, each corresponding in shape to the dental flosser.

After the dental flosser is taken from the second injection molding machine 104, additional steps may be carried out to further process the dental flosser. These further steps may include: securing or processing the protruding ends of the dental floss, adding one or more flavor (e.g., mint) or oral care agents to the dental floss, and collecting and packaging the finished dental flosser products.

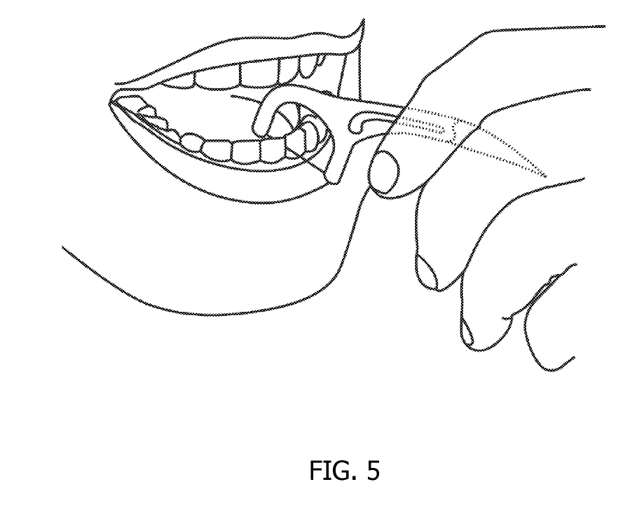

One aspect of the invention relates to methods for dental cleaning and gum stimulation. An example method is schematically illustrated in FIGS. 5 to 7. In this example method, a user uses a dental flosser which has a toothpick and gum stimulator portion made of a first material and a floss holder portion made of a second material, wherein the first material is softer than the second material. For example, the dental flosser could be dental flosser 10 as described in the present disclosure.

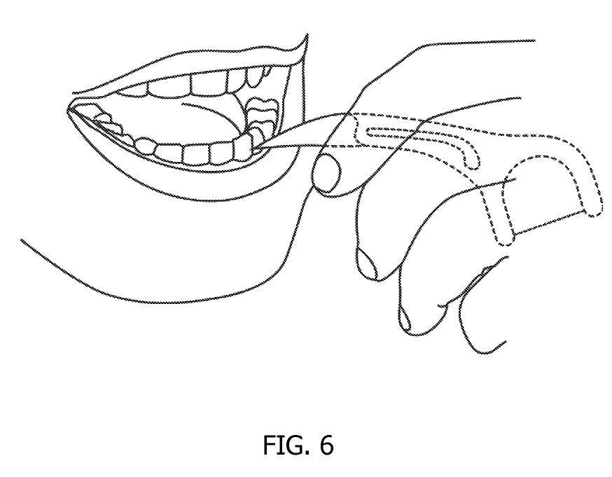

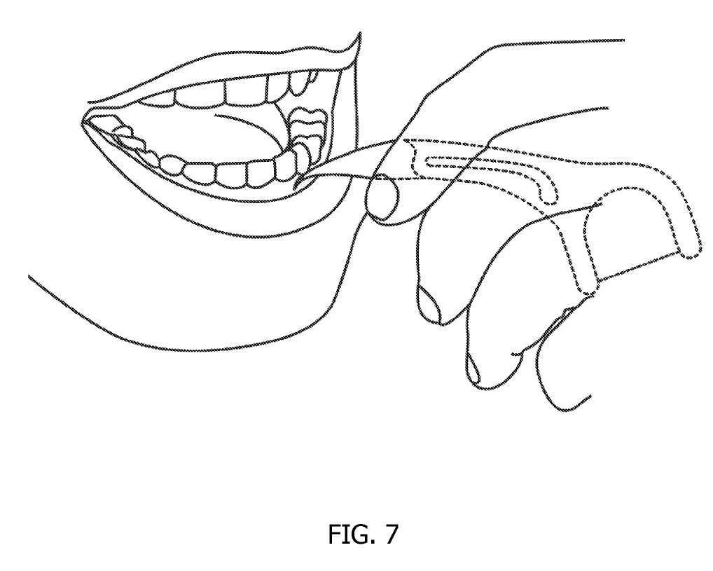

In this example method, the user places the floss holder potion of the dental flosser toward his or her mouth and flosses his or her teeth using the dental floss of the dental flosser. This step is shown in FIG. 5. The user turns the dental flosser around and places the toothpick or gum stimulator portion of the dental flosser toward his or her mouth, and uses the toothpick portion to clean his or her teeth (e.g., to remove food particles between teeth). This step is shown in FIG. 6. The user may also use the gum stimulator portion of the dental flosser to massage his or her gums. This step is shown in FIG. 7. For example, the user may press the head of the gum stimulator portion of the dental flosser gently against a surface area of the gum, moving the head of the gum stimulator portion in a circular movement on the surface area of the gum to stimulate blood circulation to the gum.

An advantage of the method is that a user would be more likely to remember to massage his or her gums using the gum stimulator portion of the dental flosser when the user is carrying out the daily task of flossing his or her teeth. This is because the gum stimulator is attached to the dental flosser. If the gum stimulator is a separate tool, the user may simply forget to use the gum stimulator.

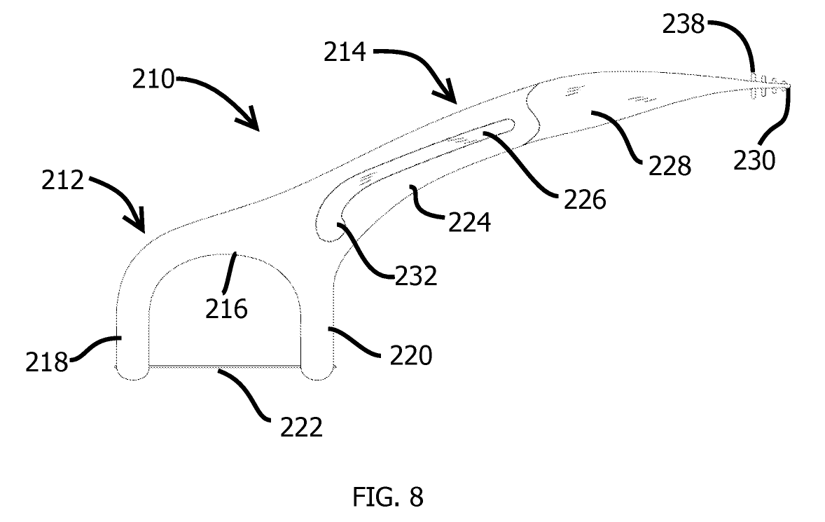

FIG. 8 shows a dental flosser 210 according to another example embodiment of the invention. Dental flosser 210 comprises many of the same features and elements as dental flosser 10. Parts of dental flosser 210 corresponding to those in dental flosser 10 are given the same reference numerals, but preceded by the digit 2. Similar to dental flosser 10, dental flosser 210 comprises a tail portion 228 made of a first material and a floss holder portion 212 made of a second material.

Tail portion 228 of dental flosser 210 comprises an interdental brush portion located at its end. The interdental brush portion comprises a plurality of protrusions 238 extending from an end portion of tail portion 228. The plurality of protrusion 238 may be made of the same first material as the rest of tail portion 238. The interdental brush portion may be used as an interdental brush to be inserted by a user into a gap between the user's gum and two adjacent teeth (called interdental triangle) to clean the interdental triangle. In some particular embodiments, tail portion 228 of dental flosser 210 functions not only as an interdental brush, but also as a toothpick and/or a gum stimulator. A user may use the tapered end 230 to contact the user's teeth (as a toothpick) or to contact the user's gums (as a gum stimulator).

As will be apparent to those skilled in the art in the light of the foregoing disclosure, many alterations and modifications are possible in the practice of this invention. The scope of the claims should not be limited by the preferred embodiments set forth in the examples, but should be given the broadest interpretation consistent with the description as a whole.

What is claimed is:

1. A dental flosser comprising:
a “U”-shaped or “V”-shaped floss holder portion which comprises a pair of spaced apart arms holding a length of dental floss, and
a handle portion extending from the floss holder portion,
wherein the handle portion comprises a tail portion at a distal end of the handle portion opposite from the floss holder portion,
wherein the tail portion is made of a first material, and the floss holder portion is made of a second material which is different from the first material.

2. The dental flosser according to claim 1, wherein the tail portion comprises a tapered end and functions as a toothpick or a gum stimulator or an interdental brush or a combination thereof.

3. The dental flosser according to claim 2, wherein the first material of which the tail portion is made has a first hardness, and the second material of which the floss holder portion is made has a second hardness, and the first hardness is less than the second hardness.

4. The dental flosser according to claim 2, wherein the first material of which the tail portion is made is softer or more flexible than the second material of which the floss holder portion is made.

5. The dental flosser according to claim 2, wherein the first material is soft or flexible enough such that the toothpick or the gum stimulator of the tail portion may be used safely by a user without the risk of cutting or bruising the user's gum or skin.

6. The dental flosser according to claim 2, wherein the second material is hard or rigid enough such that the floss holder portion can hold the length of floss in a taut or tensioned condition.

7. The dental flosser according to claim 2, wherein the handle portion comprises a sheath portion extending from the floss holder portion, and an insert portion extending from the tail portion, and the sheath portion encases or partially encases the insert portion.

8. The dental flosser according to claim 7, wherein the sheath portion is made of the second material, and the insert portion is made of the first material.

9. The dental flosser according to claim 8, wherein the sheath portion comprises a window on a side surface, and a part of the insert portion extends or is exposed through the window.

10. The dental flosser according to claim 8, wherein the tail portion and the inert portion are made of a first thermoplastic material, and the floss holder portion and the sheath portion is made of a second thermoplastic material, and the dental flosser is manufactured in an injection molding process such that the tail portion and the inert portion and the floss holder portion and the sheath portion are integrally united.

11. The dental flosser according to claim 2, wherein the first and second materials are thermoplastic materials, and wherein the first material of which the tail portion is made has a first glass-transition temperature (Tg1), and the second material of which the floss holder portion is made has a second glass-transition temperature (Tg2), and Tg1 is lower than Tg2.

12. The dental flosser according to claim 2, wherein the first material comprises ethylene-vinyl acetate (EVA) copolymer or low density polyethylene (LDPE), and the second material comprises polypropylene (PP) or polystyrene (PS) or ABS.

13. A method for manufacturing the dental flosser of claim 1, the method comprising: flowing a first fluid plastic material into a first mold, letting the first fluid plastic material to harden to form a first portion of the dental flosser, transferring the first portion of the dental flosser to a second mold, flowing a second fluid plastic material into the second mold, and letting the second fluid plastic material to harden to form the dental flosser that comprises both the first portion and the second portion.

14. The method according to claim 13, wherein the first mold comprises a mold cavity that corresponds in shape to the first portion of the dental flosser, and the second mold comprises a mold cavity that corresponds in shape to the entire dental flosser.

15. The method according to claim 14, wherein the first mold comprises a plurality of mold cavities each corresponding in shape to the first portion of the dental flosser, and the second mold comprises a plurality of mold cavities each corresponding in shape to the entire dental flosser, and wherein the first and second mold together can manufacture a plurality of dental flossers at the same time.

16. The method according to claim 15, wherein a robotic arm picks up and transfers a plurality of the first portions of the dental flossers from the first mold to the second mold.

17. A method of using the dental flosser of claim 2, the method comprising: placing the floss holder potion of the dental flosser toward a person's mouth and flossing the person's teeth using the dental floss of the dental flosser; turning the dental flosser around and placing the toothpick portion of the dental flosser toward the person's mouth, and using the toothpick portion to remove food particles from between the person's teeth; and pressing a head of the gum stimulator portion of the dental flosser gently against a surface area of the person's gum, moving the head of the gum stimulator portion on the surface area of the person's gum to stimulate blood circulation to the gum.

18. A method according to claim 17, wherein the first material is soft or flexible enough such that the toothpick or the gum stimulator may be used safely by a user without the risk of cutting or bruising the user's gums or skin, and at the same time the first material is sufficiently hard or rigid to allow the user to apply a force through the toothpick or gum stimulator to a target area of the user's gum or teeth, and wherein the second material is hard or rigid enough such that the floss holder portion can hold the length of floss in a taut or tensioned condition.

19. The dental flosser according to claim 2, wherein the tail portion comprises a plurality of protrusions to form an interdental brush portion.
